(19) United States
(12) Patent Application Publication
(10) Pub. No.: US 2025/0303315 A1
(43) Pub. Date: Oct. 2, 2025

(54) Pen-Spinner Fidget Device

(71) Applicant: Taylor Capoziello, Indian Land, SC (US)

(72) Inventor: Taylor Capoziello, Indian Land, SC (US)

(21) Appl. No.: 19/013,671

(22) Filed: Jan. 8, 2025

Related U.S. Application Data
(60) Provisional application No. 63/572,931, filed on Apr. 2, 2024.

(51) Int. Cl. A63H 33/00; A63H 1/00; B43K 23/00; B43K 23/008

(52) U.S. Cl. CPC A63H 33/003; A63H 1/00; B43K 23/00; B43K 23/008

(57) ABSTRACT

A pen-spinner fidget device is provided. The device is a multifunctional device designed as both a fidget toy and a holder for writing instruments, comprising a body shaped to resemble a pistol grip for enhanced ergonomics and comfort. The device's body includes an integrated grip with finger grooves and textured surfaces, ensuring a secure hold that is resistant to slippage and strain, particularly during extended use. At the top of the device, a flexible fastener holds a writing utensil, allowing it to spin freely around a rotation point, typically a ball-and-socket joint, enabling multidirectional movement for fidgeting. This spinning mechanism provides a stress-relieving, repetitive motion that mimics traditional fidget spinners, supporting focus and relaxation. Additionally, the invention outlines a method for use, where users secure a writing utensil in the fastener and engage in rotational motion, which can aid in concentration and reduce anxiety during focused activities.

### CROSS-REFERENCE TO RELATED APPLICATION

The present application claims priority to, and the benefit of, U.S. Provisional Application No. 63/572,931, which was filed on Apr. 2, 2024, and is incorporated herein by reference in its entirety.

### FIELD OF THE INVENTION

The present invention relates generally to the field of fidget devices. More specifically, the present invention relates to a combined fidget toy and writing utensil holder with an ergonomic, pistol-grip-shaped body featuring a textured, contoured grip for secure handling. A flexible fastener on the top of the device holds a pen or pencil, enabling it to spin around a rotation point for stress-relieving, repetitive motion that can improve focus and reduce anxiety. Accordingly, the present disclosure makes specific reference thereto. Nonetheless, it is to be appreciated that aspects of the present invention are also equally applicable to other like applications, devices, and methods of manufacture.

### BACKGROUND

Fidget spinners are handheld devices designed to spin around a central bearing, providing users with a calming or focusing experience through repetitive motion. These devices have gained traction among individuals who struggle with attention disorders, anxiety, or sensory processing issues, as the rhythmic spinning can offer a sensory outlet. By occupying their hands, some users report improved focus on tasks that require sustained attention, such as studying, working on a computer, or attending meetings. Without tools like fidget spinners, individuals may find it challenging to manage their attention, potentially impacting their productivity and completion of tasks across school, work, and daily responsibilities. However, traditional fidget spinners are limited in their applications, as they serve no additional function beyond spinning. This limitation can be restrictive in settings where a multi-functional device could enhance the user's experience, particularly in educational or professional environments.

Therefore, there exists a long-felt need in the art for the pen-spinner fidget device that provides a dual-purpose tool, combining fidget functionality with the utility of a writing implement. There also exists a long-felt need in the art for the pen-spinner fidget device that offers users a calming, sensory outlet while fitting seamlessly into educational and professional settings. Moreover, there exists a long-felt need in the art for the pen-spinner fidget device that serves as a discreet, versatile, and portable tool for individuals across diverse age groups.

The subject matter disclosed and claimed herein, in one embodiment thereof, comprises a pen-spinner fidget device. The device is a multifunctional device designed as both a fidget toy and a holder for writing instruments, comprising a body shaped to resemble a pistol grip for enhanced ergonomics and comfort. The device's body includes an integrated grip with finger grooves and textured surfaces, ensuring a secure hold that is resistant to slippage and strain, particularly during extended use. At the top of the device, a flexible fastener holds a writing utensil, allowing it to spin freely around a rotation point, typically a ball-and-socket joint, enabling multidirectional movement for fidgeting. This spinning mechanism provides a stress-relieving, repetitive motion that mimics traditional fidget spinners, supporting focus and relaxation. Additionally, the invention outlines a method for use, where users secure a writing utensil in the fastener and engage in rotational motion, which can aid in concentration and reduce anxiety during focused activities.

In this manner, the pen-spinner fidget device of the present invention accomplishes all the foregoing objectives by merging the features of a fidget spinner with a practical writing implement. The device includes a pistol grip with an attached ball and socket mechanism that enables smooth spinning of a pen, pencil, or similar utensil, allowing the user to fidget without disrupting their tasks. The compact design provides both a calming activity and a writing tool, making it suitable for use in classrooms, workplaces, or at home. As a multi-functional device, the pen-spinner fidget device meets the needs of individuals seeking a discreet, purposeful fidget aid that enhances focus and supports productivity in a range of environments.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pen-spinner fidget device. The device is comprised of a multifunctional tool that integrates the features of a fidget toy with a holder for writing instruments. The device includes a body shaped in the preferred embodiment as a pistol grip to provide ergonomic comfort and secure handling. This shape fits naturally in the user's hand, promoting controlled use over prolonged periods. Alternative body shapes, such as cylindrical or contoured forms, may be employed to meet varied ergonomic preferences while maintaining ease of use.

The body features an integrated grip designed to facilitate natural finger placement for a secure hold. This grip may include finger grooves and is available in a textured surface, such as ridges or grooves, to prevent slippage and enhance tactile feedback. Non-slip materials, such as rubber, silicone, or thermoplastic elastomers, are recommended to ensure durability and comfort.

The device incorporates a fastener mounted on the top surface to hold a writing utensil, such as a pen or pencil, allowing it to function as a fidget spinner. The fastener is flexible to accommodate various sizes of writing instruments and is connected via a rotation point that enables multidirectional spinning. The preferred embodiment features a ball-and-socket joint for smooth, 360-degree rotation, providing the user with an outlet for repetitive motion, supporting focus, and relaxation.

The rotation point may utilize various joint types, including ball-and-socket, swivel, or hinge mechanisms, to allow multidirectional movement. The ball-and-socket joint provides 360-degree rotation relative to the body, permitting spinning in any direction and emulating the motion of a traditional fidget spinner to reduce stress and enhance concentration.

The device is also comprised of a method of use, whereby a user first provides the device with a contoured grip, top surface, fastener, and rotation point. The user secures a writing utensil within the fastener and initiates fidgeting by rotating or spinning the utensil using the rotation point. This activity provides tactile engagement, which may help improve focus, alleviate anxiety, and aid concentration during attention-intensive tasks.

This innovative device offers an effective solution for users seeking tools to promote focus and manage anxiety. Its dual functionality as a writing instrument holder and fidget toy makes it a practical tool for enhancing productivity and providing sensory engagement.

Accordingly, the pen-spinner fidget device of the present invention is particularly advantageous as it merges the features of a fidget spinner with a practical writing implement. The device also allows the user to fidget without disrupting their tasks. The compact design provides both a calming activity and a writing tool, making it suitable for use in classrooms, workplaces, or at home. As a multi-functional device, the pen-spinner fidget device meets the needs of individuals seeking a discreet, purposeful fidget aid that enhances focus and supports productivity in a range of environments.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a pen-spinner fidget device of the present invention with an unattached writing utensil in accordance with the disclosed architecture;

FIG. 2 illustrates a side view of one potential embodiment of a pen-spinner fidget device of the present invention with an attached writing utensil in accordance with the disclosed architecture; and

FIG. 3 illustrates a flowchart of a method of using one potential embodiment of a pen-spinner fidget device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for the pen-spinner fidget device that provides a dual-purpose tool, combining fidget functionality with the utility of a writing implement. There also exists a long-felt need in the art for the pen-spinner fidget device that offers users a calming, sensory outlet while fitting seamlessly into educational and professional settings. Moreover, there exists a long-felt need in the art for the pen-spinner fidget device that serves as a discreet, versatile, and portable tool for individuals across diverse age groups.

The present invention, in one exemplary embodiment, is comprised of a pen-spinner fidget device. The device is a multifunctional tool that combines the features of a fidget toy with a holder for writing instruments. The device includes a body, which in the preferred embodiment, is shaped like a pistol grip for ergonomic comfort and secure handling. This shape naturally fits the user's hand, supporting controlled use over extended periods. Alternative body shapes, such as cylindrical or contoured designs, may be used to suit different ergonomic preferences while maintaining ease of use.

The body includes an integrated grip that facilitates natural finger placement for a secure hold. This grip may incorporate finger grooves and a textured surface, such as ridges or grooves, to prevent slippage and enhance tactile feedback. Non-slip materials, including rubber, silicone, or thermoplastic elastomers, are recommended to provide durability and comfort.

The device also includes a fastener mounted on the top surface to hold a writing utensil, such as a pen or pencil, enabling it to serve as a fidget spinner. The fastener is flexible to fit various sizes of writing instruments and is connected through a rotation point that allows multidirectional spinning. The preferred embodiment uses a ball-and-socket joint to enable smooth, 360-degree rotation, offering an outlet for repetitive motion that promotes focus and relaxation.

The rotation point may use various joint types, including ball-and-socket, swivel, or hinge mechanisms, to allow multidirectional movement. The ball-and-socket joint allows for 360-degree rotation relative to the body, enabling spinning in any direction and mimicking the motion of a traditional fidget spinner to help reduce stress and enhance concentration.

The device is also provided with a method of use, where a user first assembles it with the contoured grip, top surface, fastener, and rotation point. The user secures a writing utensil within the fastener and initiates fidgeting by rotating or spinning the utensil using the rotation point. This activity delivers tactile engagement, which may aid in improving focus, reducing anxiety, and supporting concentration during attention-intensive tasks.

This device effectively addresses the needs of users seeking tools that enhance focus and manage anxiety. Its dual functionality as both a writing instrument holder and fidget toy makes it a practical tool for increasing productivity and providing sensory engagement.

The pen-spinner fidget device of the present invention is particularly beneficial as it merges the qualities of a fidget spinner with a practical writing implement. It allows the user to fidget without interrupting their tasks. Its compact design offers both a calming activity and a writing tool, making it suitable for use in classrooms, workplaces, or at home. As a multifunctional device, the pen-spinner fidget device provides a discreet and purposeful fidget aid that promotes focus and supports productivity across various settings.

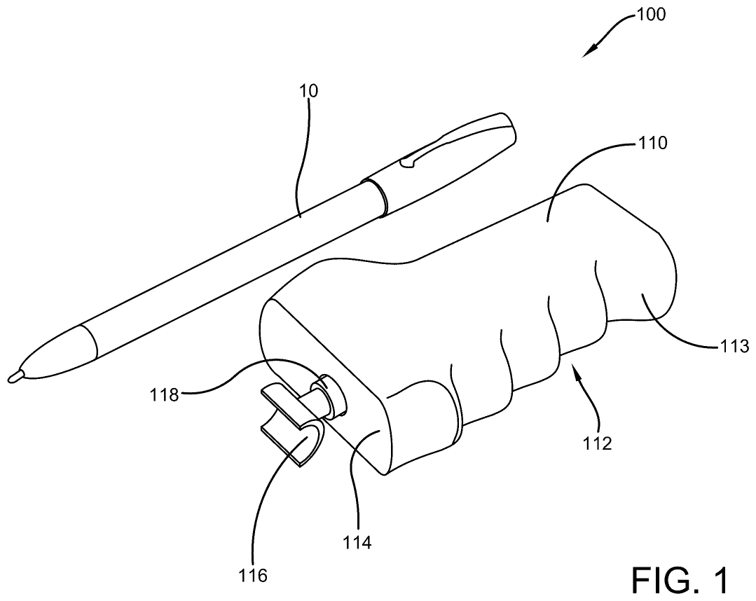

Referring initially to the drawings, FIG. 1 illustrates a perspective view of one potential embodiment of a pen-spinner fidget device 100 of the present invention with an unattached writing utensil 10 in accordance with the disclosed architecture. The device 100 is comprised of an innovative tool that combines the functionality of a fidget toy with a practical writing instrument holder. The device 100 is comprised of a body 110, which in the preferred embodiment, is shaped to resemble a pistol grip. This ergonomic shape enhances comfort and allows users to maintain a secure hold on the device 100, even during prolonged use. The pistol-grip shape provides a natural fit within the contours of the user's hand, allowing for comfortable, controlled handling. Alternative shapes, such as cylindrical, elongated, or contoured bodies, may also be implemented to accommodate different grip preferences, so long as these shapes ensure ease of use and ergonomic efficiency.

The body 110 includes an integrated grip 112. The grip 112 in the preferred embodiment is contoured to support a natural finger placement, allowing for a secure grasp that feels intuitive to the user. The grip may be comprised of at least one finger groove 113 or other ergonomic shaping that aids the user in holding the device 100 comfortably, reducing strain and enhancing control. To prevent slippage, the grip 112 may incorporate a textured surface, which could be achieved through a variety of patterns, such as raised ridges, recessed grooves, or checkered textures. These textures provide additional friction and tactile feedback, ensuring that the device 100 remains securely in the user's hand even with light, repetitive movements. Suitable materials for the grip 112 include non-slip options such as rubber, silicone, or thermoplastic elastomers, as well as other grip-enhancing materials that offer both durability and comfort.

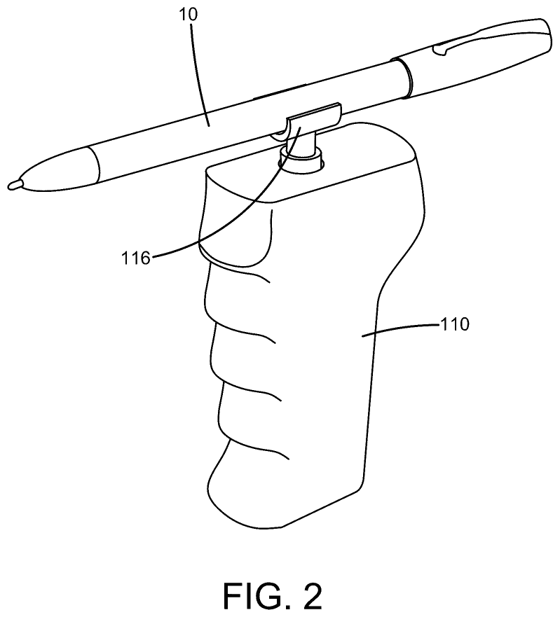

Mounted on the top surface 114 of the body 110, the device 100 features a fastener 116 designed to securely hold a writing utensil 10, such as a pen or pencil, as seen in FIG. 2. This fastener 116 is configured to allow the writing utensil 10 to spin freely when secured, facilitating the device's 100 dual function as a fidget spinner. In one embodiment, the fastener 116 is flexible to accommodate a plurality of sizes and types of writing instruments. The fastener 116 is connected to the top surface 114 via a rotation point 118, enabling rotational movement around at least one axis. In the preferred embodiment, the rotation point 118 comprises a ball-and-socket mechanism, which permits the writing utensil 10 to pivot smoothly in all directions. This multidirectional rotation capability enables the user to spin the utensil 10 while holding the device 100 in one hand, offering a sensory outlet that can assist with concentration and relaxation.

The rotation point 118 may encompass a variety of joint types to achieve multidirectional movement, including, but not limited to, ball-and-socket joints, swivels, or hinges. Each of these joint types allows for a different range and type of movement, depending on the desired configuration. The preferred ball-and-socket joint offers 360-degree rotation relative to the vertical axis of the body 110, allowing the user to spin or angle the writing instrument in any direction. This spinning action mimics the function of a traditional fidget spinner, allowing the user to enjoy repetitive motion that can reduce stress and increase focus.

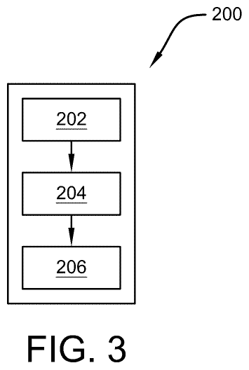

The present invention is also comprised of a method of using 200 the device 100, as seen in FIG. 3. First, a device 100 is provided, comprising a body 110 with a contoured grip 112, a top surface 114, a fastener 116 configured to hold a writing utensil 10, and a rotation point 118 that enables multidirectional spinning of the writing utensil 10 [Step 202]. Next, the user secures a writing utensil 10, such as a pen or pencil, within the fastener 116 [Step 204]. Once the writing utensil 10 is secured, the user may initiate fidgeting by manually rotating or spinning the writing utensil 10 using the rotation point 118 [Step 206]. As the user spins or tilts the writing utensil, they may experience the tactile benefits associated with repetitive motion, which can enhance focus, alleviate anxiety, and aid in concentration during tasks that require prolonged attention.

Through this unique combination of features, the device 100 offers an effective and user-friendly solution for individuals seeking tools that promote focus and manage anxiety. Its multifunctional design allows it to serve as both a holder for writing instruments and an interactive fidget device, making it a valuable tool for individuals in need of a sensory engagement option that supports their productivity and focus.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pen-spinner fidget device” and “device” are interchangeable and refer to the pen-spinner fidget device 100 of the present invention.

Notwithstanding the foregoing, the pen-spinner fidget device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the pen-spinner fidget device 100 as shown in the FIGS. are for illustrative purposes only, and that many other sizes and shapes of the pen-spinner fidget device 100 are well within the scope of the present disclosure. Although the dimensions of the pen-spinner fidget device 100 are important design parameters for user convenience, the pen-spinner fidget device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pen-spinner fidget device comprising:
a body comprised of a grip;
a fastener positioned on the body, the fastener configured to securely hold a writing utensil; and
a rotation point connecting the fastener to the body.

2. The pen-spinner fidget device of claim 1, wherein the body is comprised of a pistol-grip shape.

3. The pen-spinner fidget device of claim 1, wherein the grip is comprised of a finger groove.

4. The pen-spinner fidget device of claim 1, wherein the grip is comprised of a textured surface.

5. The pen-spinner fidget device of claim 4, wherein the textured surface is comprised of a raised ridge.

6. The pen-spinner fidget device of claim 1, wherein the grip is comprised of a rubber, a silicone, or a thermoplastic elastomer to improve grip.

7. The pen-spinner fidget device of claim 1, wherein the fastener is comprised of a flexible fastener.

8. The pen-spinner fidget device of claim 1, wherein the rotation point is comprised of a ball-and-socket joint.

9. A pen-spinner fidget device comprising:
a body;
a contoured grip integrated into the body, the contoured grip comprising a finger groove;
a fastener configured to hold a writing utensil and allow free spinning of the writing utensil when secured;
a ball-and-socket joint forming a rotation point between the fastener and the body, the ball-and-socket joint configured for 360-degree rotation of the writing utensil.

10. The pen-spinner fidget device of claim 9, wherein the body is comprised of a cylindrical shape.

11. The pen-spinner fidget device of claim 9, wherein the body is comprised of a contoured shape.

12. The pen-spinner fidget device of claim 9, wherein the fastener is comprised of a clamp.

13. The pen-spinner fidget device of claim 12, wherein the clamp is comprised of an adjustable clamp.

14. The pen-spinner fidget device of claim 9, wherein the contoured grip is comprised of a non-slip surface.

15. The pen-spinner fidget device of claim 9, wherein the ball-and-socket joint allows the writing utensil to spin in a 360-degree motion relative to a vertical axis of the body.

16. A method of using a pen-spinner fidget device, the method comprising the following steps:
providing a pen-spinner fidget device comprised of a body with a top surface, a grip with a textured, non-slip surface, a fastener mounted on the top surface of the body, and a rotation point configured for multidirectional movement of a writing utensil;
securing the writing utensil within the fastener; and
rotating the writing utensil around the rotation point, allowing the writing utensil to spin freely and provide repetitive motion.

17. The method of using a pen-spinner fidget device of claim 16, wherein the grip is comprised of a recessed groove.

18. The method of using a pen-spinner fidget device of claim 16, wherein the rotation point allows the writing utensil to spin in a 360-degree motion relative to a vertical axis of the body.

19. The method of using a pen-spinner fidget device of claim 16, wherein the body is comprised of a pistol-grip shape.

20. The method of using a pen-spinner fidget device of claim 16, wherein the fastener is comprised of a flexible fastener.
